(19) United States
(12) Patent Application Publication
(10) Pub. No.: US 2026/0316775 A1
(43) Pub. Date: Oct. 15, 2026

(54) APPARATUS AND METHOD FOR CONTROLLING HYBRID VEHICLE, AND HYBRID VEHICLE HAVING SAME

(71) Applicants: Hyundai Motor Company, Seoul (KR); Kia Corporation, Seoul (KR)

(72) Inventors: Min Su KIM, Hwaseong-si (KR); Gee Wook SHIN, Hwaseong-Si (KR); Jung Un AN, Hwaseong-Si (KR)

(73) Assignees: Hyundai Motor Company, Seoul (KR); Kia Corporation, Seoul (KR)

(21) Appl. No.: 19/362,152

(22) Filed: Oct. 17, 2025

(30) Foreign Application Priority Data
Apr. 11, 2025 (KR) 10-2025-0047547

(51) Int. Cl. B60W 50/12; B60L 58/13; B60W 10/08; B60W 30/182; B60W 50/14

(52) U.S. Cl. CPC B60W 50/12; B60L 58/13; B60W 10/08; B60W 30/182; B60W 50/14; B60L 2250/16; B60W 2050/146; B60W 2510/244

(57) ABSTRACT

A hybrid vehicle control apparatus for controlling a hybrid vehicle including a hybrid powertrain of an engine and a drive motor, includes a vehicle terminal, when entering a safe boarding and alighting assistance mode and then receiving an instruction to use a registered travel path, the vehicle terminal displaying path guidance information based on the pre-registered travel path, and a controller configured for determining a state of the vehicle based on a location of the vehicle and vehicle state information after entering the safe boarding and alighting assistance mode, and performing limit control with respect to the hybrid powertrain when the vehicle is in a state of being able to board and alight.

### CROSS REFERENCE TO RELATED APPLICATION

The present application claims priority to Korean Patent Application No. 10-2025-0047547, filed Apr. 11, 2025, in the Korean Intellectual Property Office, the entire contents of which are incorporated herein for all purposes by this reference.

### Field of the Present Disclosure

The present disclosure relates to a control technique of a hybrid vehicle. More particularly, the present disclosure relates to an apparatus and a method for controlling a hybrid vehicle, and a hybrid vehicle having the same, the apparatus being implemented to control the vehicle based on a vehicle stop location on a travel path and a vehicle state, thus ensuring efficient travel of the vehicle and the safety of a vehicle user.

### BACKGROUND

When the SOC value of a high-voltage battery in a hybrid vehicle with an engine and a motor as a power source is reduced less than or equal to a certain level, engine starting may occur while the vehicle is in a stop state to charge the high-voltage battery.

When the engine starts while a vehicle user enters or exits the vehicle, the exhaust gas can negatively impact the health of the vehicle user.

An engine start strategy is an operational strategy focusing on the state of the vehicle and does not consider the boarding and alighting of vehicle users, and the vehicle drive force control strategy does not take into account the boarding and alighting of a vehicle user.

Therefore, engine start strategy and vehicle drive force control strategy considering the boarding and alighting of the vehicle user are required.

Meanwhile, vehicles such as children's school vehicles, buses, etc., may easily learn about a travel path because the vehicles follow a nearly consistent travel path when they are operated according to their purpose.

When the engine start strategy and the vehicle drive force control strategy are planned while reflecting the travel path learning of the vehicle, improved vehicle services may be provided.

The matters described above as background technology are intended to provide a better understanding of the context of the present disclosure and are not intended to form a disclaimer of the related art known to those of ordinary skill in the art.

### BRIEF SUMMARY

In various aspects of the present disclosure, the present disclosure is to provide an apparatus and a method for controlling a hybrid vehicle, and a hybrid vehicle having the same, the apparatus being implemented to perform travel path learning of the vehicle and allow the vehicle to travel efficiently.

In various aspects of the present disclosure, the present disclosure is to provide an apparatus and a method for controlling a hybrid vehicle, and a hybrid vehicle having the same, the apparatus being implemented to ensure the SOC value of a battery in advance in consideration of boarding and alighting of a vehicle user, thus preventing an engine from starting to charge the battery when the vehicle is stopped.

In various aspects of the present disclosure, the present disclosure is to provide an apparatus and a method for controlling a hybrid vehicle, and a hybrid vehicle having the same, the apparatus being implemented to limit a drive force of the vehicle in consideration of boarding and alighting of a vehicle user to prevent generation of the drive force of the vehicle even when a driver accidentally shifts a transmission gear and manipulates an accelerator pedal.

The technical problems to be achieved in the present disclosure are not limited to the above technical problem, and other problems not mentioned will be clearly understood by those skilled in the art from the description below.

In various aspects of the present disclosure, there is provided an apparatus for controlling a hybrid vehicle including a hybrid powertrain of an engine and a drive motor, the apparatus including: a vehicle terminal, when entering a safe boarding and alighting assistance mode and then receiving an instruction to use a registered travel path, the vehicle terminal displaying path guidance information based on the pre-registered travel path; and a controller configured for determining a state of the vehicle based on a location of the vehicle and vehicle state information after entering the safe boarding and alighting assistance mode, and performing limit control with respect to the hybrid powertrain when the vehicle is in a state of being able to board and alight.

In various aspects of the present disclosure, when the instruction to use the registered travel path is input, the vehicle terminal may display a registered travel path list, determine whether a non-stop station is selected from a travel path selected from the travel path list, and provide guidance of a travel path based on whether the non-stop station is selected.

In various aspects of the present disclosure, when the non-stop station is selected, the vehicle terminal may exclude the selected non-stop station from the travel path and then search a new travel path, and provide guidance of the new travel path searched.

In various aspects of the present disclosure, when the non-stop station is not selected, the vehicle terminal may provide guidance of the selected travel path.

In various aspects of the present disclosure, when an instruction to register a new travel path is input after entering the safe boarding and alighting assistance mode, the vehicle terminal may store a travel path corresponding to a travel of the vehicle and a station on the travel path.

In various aspects of the present disclosure, when the vehicle terminal receives a driving force control event signal from the controller during the travel of the vehicle, the vehicle terminal may display a pop-up window that inquires whether a current location of the vehicle is stored as a station, and store the current location of the vehicle as a station when a storing instruction is input through the pop-up window.

In various aspects of the present disclosure, when entering the safe boarding and alighting assistance mode, the vehicle terminal may output an instruction to enter the safe boarding and alighting assistance mode to the controller.

In various aspects of the present disclosure, when the vehicle is in a travel state, the controller may be configured for controlling a battery so that a state of charge (SOC) value of the battery of the vehicle reaches a preset safe boarding and alighting charging target SOC value.

In various aspects of the present disclosure, the preset safe boarding and alighting charging target SOC may be preset greater than or equal to electric power consumed by an electric field load of the vehicle when the vehicle is stopped.

In various aspects of the present disclosure, the state of being able to board and alight may be a state in which the vehicle is stopped and located at a station on the travel path with a door of the vehicle opened.

In various aspects of the present disclosure, when receiving a station arrival signal from the vehicle terminal, the controller may be configured to determine that the vehicle is located at the station on the travel path.

In various aspects of the present disclosure, when the vehicle is in the state of being able to board and alight, the controller may maintain the engine in an OFF state.

In various aspects of the present disclosure, when the vehicle is in the state of being able to enter and exit the vehicle, the controller may limit the drive force output of the hybrid powertrain.

In various aspects of the present disclosure, when limiting the drive force output of the hybrid powertrain, the controller may be configured for controlling a gear of the vehicle so that the gear is maintained in an N position.

In various aspects of the present disclosure, when limiting the drive force output of the hybrid powertrain, the controller may be configured for controlling an electronic parking brake of the vehicle so that the electronic parking brake is maintained in an engaged state.

In various aspects of the present disclosure, the vehicle terminal may include: a communication module implemented to communicate with electronic devices in the vehicle; a memory implemented to store a safe boarding and alighting assistance algorithm; a user interface implemented to receive an instruction from a user and display information; and a processor performing the safe boarding and alighting assistance algorithm when entering a safe boarding and alighting mode.

In various aspects of the present disclosure, the controller may include: a communication module implemented to communicate with electronic devices in the vehicle; a memory implemented to store a safe boarding and alighting assistance algorithm; and a processor performing the safe boarding and alighting assistance algorithm when entering the safe boarding and alighting mode.

According to an exemplary embodiment of the present disclosure, there is provided a method for controlling a hybrid vehicle including a hybrid powertrain of an engine and a drive motor, the method including: entering a vehicle terminal and a controller into a safe boarding and alighting assistance mode; displaying, by the vehicle terminal, path guidance information based on a pre-registered travel path; and determining, by the controller, a state of the vehicle based on a location of the vehicle and vehicle state information; and performing, by the controller, limit control with respect to the hybrid powertrain when the vehicle is in a state of being able to board and alight.

According to an exemplary embodiment of the present disclosure, there is provided a hybrid vehicle including a hybrid powertrain of an engine and a drive motor, the hybrid vehicle including a vehicle control apparatus displaying path guidance information based on a pre-registered travel path when entering a safe boarding and alighting assistance mode, and controlling the hybrid vehicle based on a preset safe boarding and alighting assistance algorithm, wherein the vehicle control apparatus may be implemented to determine a state of the vehicle based on the safe boarding and alighting assistance algorithm, location information, and state information of the vehicle, and to perform limit control with respect to the hybrid powertrain when the vehicle is in a state of being able to board and alight.

In various aspects of the present disclosure, the vehicle control apparatus may include: a vehicle terminal providing guidance of a travel path of the vehicle based on the registered travel path, when entering the safe boarding and alighting assistance mode and then receiving an instruction to use the registered travel path; and a controller performing the boarding and alighting assistance algorithm after entering the safe boarding and alighting assistance mode.

Specific details according to various examples of the present disclosure, other than the solutions mentioned above, are included in the description and the drawings below.

In various aspects of the present disclosure, the apparatus and the method for controlling a hybrid vehicle, the hybrid vehicle having the same, the apparatus being implemented to perform travel path learning of the vehicle and allow the vehicle to travel efficiently.

In various aspects of the present disclosure, the apparatus and the method for controlling a hybrid vehicle, and the hybrid vehicle having the same are provided, and the apparatus is implemented to ensure the SOC value of a battery in advance in consideration of the boarding and alighting of a vehicle user, thus preventing an engine from starting to charge the battery in a stop state.

In various aspects of the present disclosure, the apparatus and the method for controlling a hybrid vehicle, and the hybrid vehicle having the same are provided, and the apparatus is implemented to limit a drive force of the vehicle in consideration of the boarding and alighting of the vehicle user to prevent generation of the drive force of the vehicle even when a driver accidentally shifts a transmission gear and manipulates an accelerator pedal.

In various aspects of the present disclosure, when the apparatus and the method for controlling a hybrid vehicle is applied to a vehicle, the apparatus can learn about a travel path of the vehicle, so that the vehicle can travel efficiently.

Furthermore, the apparatus ensures the SOC value of the battery in advance in consideration of the boarding and alighting of the vehicle user, thus preventing the engine from starting to charge the battery when the vehicle is stopped, so that it is possible to prevent the vehicle user from being exposed to exhaust gas, and prevent exhaust gas from negatively affecting the health of the vehicle user.

Furthermore, it is possible to prevent generation of a drive force of the vehicle even when the driver accidentally shifts the transmission gear and manipulates the accelerator pedal by limiting the drive force of the vehicle in consideration of the boarding and alighting of the vehicle user, thus ensuring the safety of the vehicle user.

Furthermore, these effects can improve the productivity of the vehicle and customer satisfaction.

The effect of the present disclosure is not limited to the above-mentioned effects, and other effects not mentioned will be clearly understood by those skilled in the art from the description below.

### BRIEF DESCRIPTION OF THE DRAWINGS

The accompanying drawings are intended to illustrate an exemplary embodiment of the present disclosure and provide examples with a detailed description. However, the technical features of present embodiments are not limited to any drawings, and the features included in each drawing may be combined with each other to form new embodiments.

FIG. 1 is a view showing an example of configuration of a vehicle control apparatus according to the exemplary embodiment of the present disclosure.

FIG. 2 is a view showing an example of a configuration of a vehicle terminal according to an exemplary embodiment of the present disclosure.

FIG. 3 is a view showing an example of a configuration of a controller according to the exemplary embodiment of the present disclosure.

FIG. 4 is a view exemplarily illustrating a method for controlling the vehicle control apparatus according to the exemplary embodiment of the present disclosure.

FIG. 5 is a view exemplarily illustrating a new travel path registration operation in FIG. 4 in detail.

FIG. 6 is a view exemplarily illustrating a travel path guidance operation in FIG. 4 in detail.

FIG. 7 is a view exemplarily illustrating a safe boarding and alighting assistance control operation S460 in FIG. 4.

FIG. 8 is a block diagram showing a power system of a vehicle to which the vehicle control apparatus according to an exemplary embodiment of the present disclosure is applied.

FIG. 9 is an example of a control block diagram for controlling the vehicle according to the exemplary embodiment of the present disclosure.

FIG. 10 is a view showing an example of a travel path registered by a new travel path registration operation of the vehicle terminal according to an exemplary embodiment of the present disclosure.

FIG. 11 is a view showing an example of a new travel path which is searched in a situation without stations 1 and 2 from FIG. 10.

### DETAILED DESCRIPTION OF THE PRESENT DISCLOSURE

In the following description, if it is decided that the detailed description of known technologies related to the present disclosure makes the subject matter of the exemplary embodiment described herein unclear, the detailed description is omitted. Furthermore, the accompanying drawings are provided only for easy understanding of the exemplary embodiment included in the specification, and the technical spirit included in the specification is not limited by the accompanying drawings, and all changes, equivalents, and replacements should be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

Singular forms are intended to include plural forms unless the context clearly indicates otherwise.

It will be further understood that the terms “comprise” or “have” used in the present specification, specify the presence of stated features, steps, operations, components, parts, or a combination thereof, but do not preclude the presence or addition of one or more other features, numerals, steps, operations, components, parts, or a combination thereof.

The suffixes “module” and “part” for the components used in the following description are provided or mixed in consideration of only the ease of writing the specification, and do not have distinct meanings or roles by themselves.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element intervening therebetween.

Furthermore, a unit or a control unit included in names is only a widely used term for a controller that is configured to control a specific function of a vehicle, and does not mean a generic function unit

The controller may include a communication device communicating with other controllers or a sensor to control the function in charge, a memory storing an operation system or a logic command and input/output information, and at least one process performing determination, calculation, and decision necessary for controlling the function in charge.

In any of the configurations described in the specification, any number of components or a variety of components may be included within the present disclosure described herein. The components may include any combination of the features described herein and may be disposed in any of the various configurations described herein. In addition to structures and arrangements of the components of the present disclosure, the concept of use and operation thereof may be applied not only to the specific embodiments included herein, but also to any number of embodiments in any combination. The exemplary embodiments including various features of various arrangements are described below with reference to the drawings.

Hereafter, the various embodiments of the present disclosure will be described in detail with reference to the accompanying drawings, and the same or similar components are given the same reference numerals regardless of the numbers of figures and are not repeatedly described.

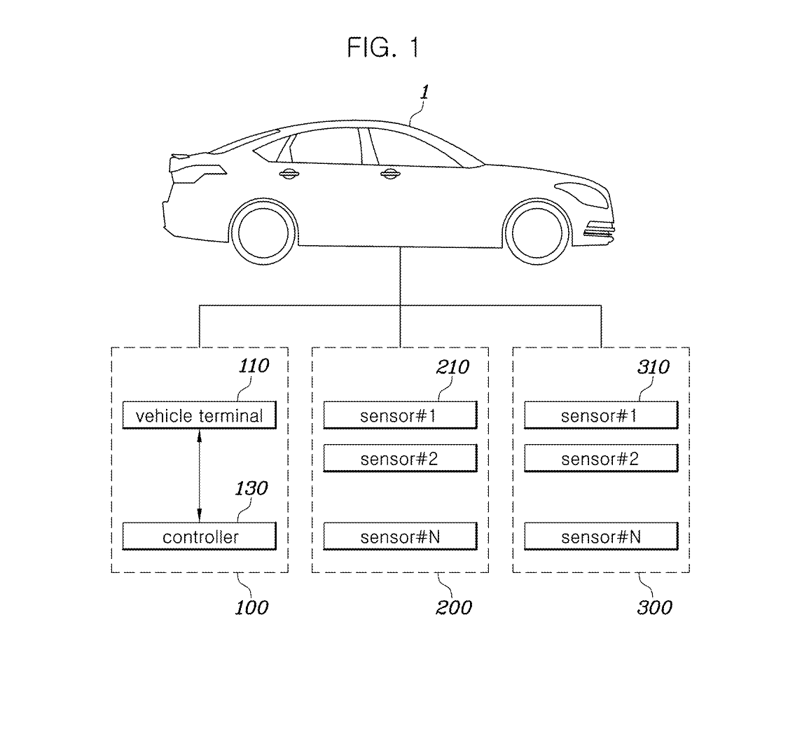

FIG. 1 is a view showing configuration of a vehicle control apparatus according to the exemplary embodiment of the present disclosure.

Referring to FIG. 1, according to the exemplary embodiment of the present disclosure, the vehicle control apparatus 100 is disposed to a vehicle 1, and when entering a safe boarding and alighting assistance mode, the vehicle control apparatus 100 may store a travel path of the vehicle 1 and control the vehicle 1 to assist the safety of an occupant (or passenger) boarding and alighting the vehicle.

According to the exemplary embodiment of the present disclosure, the vehicle 1 may include a hybrid powertrain including an engine and a motor as a driving source. For example, the vehicle 1 may be a hybrid electric vehicle (HEV), a plug-in hybrid electric vehicle (PHEV), and the like. For example, the vehicle 1 may be a vehicle which is moved along a travel path constantly for a purpose, such as a children's school bus, a public transport bus, and the like.

According to the exemplary embodiment of the present disclosure, the vehicle control apparatus 100 may enter the safe boarding and alighting assistance mode according to a user's instruction. For example, when a preset entry condition of the safe boarding and alighting assistance mode is satisfied, the vehicle control apparatus 100 may enter the safe boarding and alighting assistance mode. For example, when the vehicle enters a preset path or a preset time condition is satisfied, the vehicle control apparatus 100 may enter the safe boarding and alighting assistance mode.

According to the exemplary embodiment of the present disclosure, the vehicle control apparatus 100 includes a vehicle terminal 110 and a controller 130, and the configuration of the vehicle control apparatus 100 is not limited thereto.

According to the exemplary embodiment of the present disclosure, the vehicle 1 may include a distance measurement sensor group 200 and an image sensor group 300.

According to the exemplary embodiment of the present disclosure, the distance measurement sensor group 200 may include a plurality of distance measurement sensors 210. For example, the distance measurement sensors 210 may be properly disposed at front, rear, left and right portions of the vehicle 1, and measure a distance between each sensor and the ground or between each sensor and an obstacle (e.g., another vehicle around the vehicle 1).

Accordingly, the distance measurement sensors 210 may provide distance data to the vehicle terminal 110, based on the measured result. Accordingly, the distance measurement sensors 210 may provide distance data to the vehicle terminal 110 and the controller 130, based on the measured result.

For example, the distance measurement sensors 210 may be ultrasonic sensors, but the type of the distance measurement sensors 210 is not limited thereto. For example, the distance measurement sensors 210 may be a sensor to which a time of flight (TOF) technique is applied. For example, the distance measurement sensors 210 may be a sensor to which a moving average filter is applied.

According to the exemplary embodiment of the present disclosure, the image sensor group 300 may include a plurality of image sensors 310. The image sensors 310 may be properly disposed at front, rear, left and right portions of the vehicle 1, and may capture an image around the vehicle 1 based on a preset field of view (FOV).

According to the exemplary embodiment of the present disclosure, the image sensors 310 may provide image data based on the captured image to the vehicle terminal 110. According to the exemplary embodiment of the present disclosure, the image sensors 310 may provide the image data based on the captured image to the controller 130. According to the exemplary embodiment of the present disclosure, the image sensors 310 may provide image data based on the captured image to the vehicle terminal 110 and the controller 130.

For example, the image sensors 310 may be implemented in a charge coupled device (CCD) image sensor, a charge priming device (CPD) image sensor, a metal oxide semiconductor (MOS) image sensor, a complementary MOS (CMOS) image sensor, and the like.

For example, the image sensors 310 may be disposed at front, rear, left and right portions of the vehicle 1, and include a front image sensor, a rear image sensor, a left image sensor, and a right image sensor that are preset to capture the front, rear, left and right spaces of the vehicle 1.

The vehicle terminal 110

According to the exemplary embodiment of the present disclosure, the vehicle terminal 110 may be implemented to receive a user's instruction. For example, the vehicle terminal 110 may receive an instruction to enter the safe boarding and alighting assistance mode, and then enter the safe boarding and alighting assistance mode. For example, when entering the safe boarding and alighting assistance mode, the vehicle terminal 110 may display the safe boarding and alighting assistance mode as the travel mode-related information.

According to the exemplary embodiment of the present disclosure, when entering the safe boarding and alighting assistance mode, the vehicle terminal 110 may receive a selection of the user about registration of a new travel path.

For example, the vehicle terminal 110 may display a graphic user interface (GUI) button implemented to enable the user to select whether a new travel path is registered. For example, the vehicle terminal 110 may display a pop-up message implemented to enable the user to select whether the new travel path is registered.

For example, the vehicle terminal 110 may display a user setting mode (USM) to interface with the user. For example, the user may manipulate the USM displayed in the vehicle terminal 110 to input an instruction.

According to the exemplary embodiment of the present disclosure, the vehicle terminal 110 may be implemented to provide a navigation service.

According to the exemplary embodiment of the present disclosure, when the user selects the registration of the new travel path, the vehicle terminal 110 may enter a new travel path registration mode, and the travel path may be stored based on traveling of the vehicle 1.

According to the exemplary embodiment of the present disclosure, when the vehicle terminal 110 at the new travel path registration mode receives a drive force limitation event signal from the controller 130, the vehicle terminal 110 may display a pop-up window (station storing inquiry window) that inquires whether a current location of the vehicle 1 is stored as a station.

When a current location storing instruction is input through the station storing inquiry window, the vehicle terminal 110 may store the current location of the vehicle 1 as a station.

According to the exemplary embodiment of the present disclosure, when the vehicle 1 arrives at a start position, the vehicle terminal 110 may display a pop-up window (travel path storing inquiry window) that inquires whether the travel path is stored.

When the travel path storing instruction is input through the travel path storing inquiry window, the vehicle terminal 110 may store the travel path. According to the exemplary embodiment of the present disclosure, the travel path may include station location information.

According to the exemplary embodiment of the present disclosure, when the user selects non-registration of the new travel path, the vehicle terminal 110 may display a preset travel path list.

The vehicle terminal 110 may display a station list included in a travel path selected from the displayed travel path list, and exclude stations that are selected as exclusion stations from the station list, from the corresponding travel path.

According to the exemplary embodiment of the present disclosure, the vehicle terminal 110 may provide guidance of the preset travel path when exclusion stations are not selected. According to the exemplary embodiment of the present disclosure, when exclusion stations are selected, the vehicle terminal 110 may exclude the exclusion stations from the corresponding travel path, search a path while reflecting the selected exclusion stations, and provide guidance of the searched path.

For example, the vehicle terminal 110 may implement an in-vehicle infotainment (IVI) system. For example, the vehicle terminal 110 may be implemented in an audio video navigation (AVN) system, an audio video navigation telecommunication (AVNT) system, a cluster, a head up display, and the like.

According to the exemplary embodiment of the present disclosure, the vehicle terminal 110 may display a guidance message based on the signal provided from the controller 130.

For example, the vehicle terminal 110 may receive an engine starting limitation event signal from the controller 130, and display an engine starting limitation status message. For example, the vehicle terminal 110 may receive the drive force limitation event signal from the controller 130, and display a drive force limitation state guidance message.

According to the exemplary embodiment of the present disclosure, when the vehicle terminal 110 enters the safe boarding and alighting assistance mode, the vehicle terminal 110 may output an instruction to enter the safe boarding and alighting assistance mode to the controller 130.

According to the exemplary embodiment of the present disclosure, the vehicle terminal 110 may provide the travel path information to the controller 130. According to the exemplary embodiment of the present disclosure, when the vehicle 1 arrives at the station, the vehicle terminal 110 may output the station arrival signal to the controller 130. According to the exemplary embodiment of the present disclosure, when the vehicle 1 arrives at the station, and another vehicle is within a preset radius (e.g., 5m, 10m, etc.), the vehicle terminal 110 may output a vehicle presence warning signal to the controller 130.

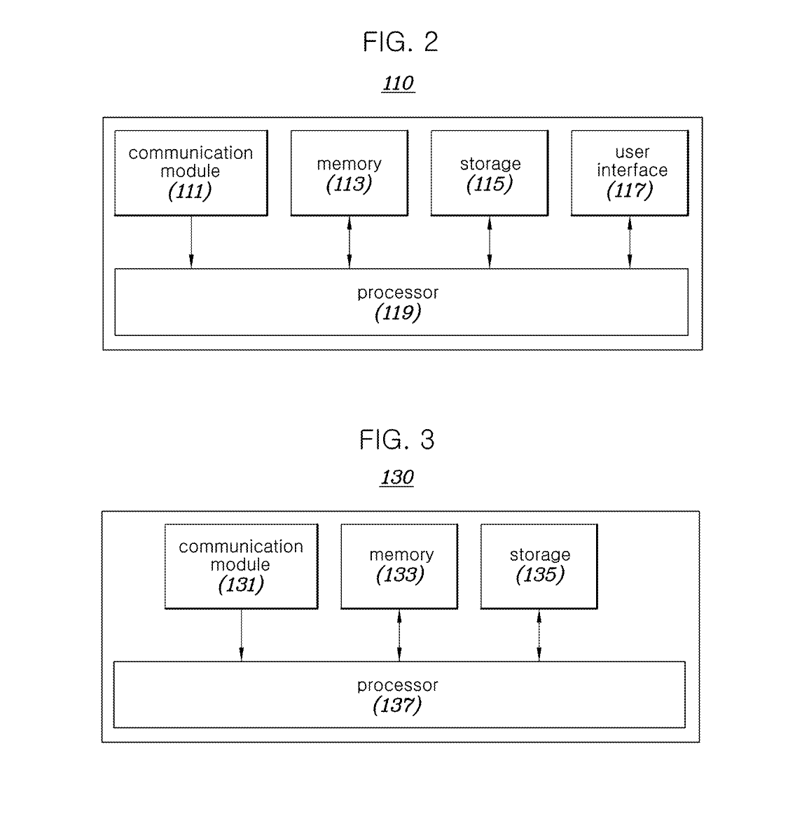

FIG. 2 is a view showing an example of a configuration of a vehicle terminal according to an exemplary embodiment of the present disclosure.

Referring to FIG. 2, the vehicle terminal 110 may include a communication module 111, a memory 113, a storage 115, a user interface 117, and a processor 119, and the configuration of the vehicle terminal 110 is not limited thereto.

The communication module 111 may include a communication circuit implemented to perform communication with the controller 130, the distance measurement sensor group 200, and the image sensor group 300, based on a preset vehicle communication protocol. For example, the communication module 111 may include a communication circuit implemented to perform communication with a server that provides a vehicle service based on a preset communication network.

The communication module 111 may receive different types of external information. The information received by the communication module 111 may be stored in the memory 113, stored in the storage 115, and transmitted to the processor 119.

For example, the vehicle communication protocol may include Local Interconnect Network (LIN), Controller Area Network (CAN), FlexRay, Ethernet, and the like, but the type of vehicle communication protocol is not limited thereto. For example, the communication network may be wireless internet technology such as wireless LAN (WLAN, Wi-Fi), Wireless Broadband (WiBro), and/or Worldwide Interoperability for Microwave Access (WiMAX), and/or mobile communication technology such as Code Division Multiple Access (CDMA), Global System for Mobile communication (GSM), Long Term Evolution (LTE), LTE-Advanced, and/or international mobile telecommunication (IMT)-2020, but the type of communication network is not limited thereto.

The memory 133 may store algorithms (or software or program), data, etc. required to perform the functions of the vehicle terminal 110. For example, the memory 113 may store algorithms, data, etc. required to perform the safe boarding and alighting mode according to the exemplary embodiment of the present disclosure by the vehicle terminal 110.

The storage 115 may store information generated or obtained by the operation of the vehicle terminal 110. For example, the storage 115 may store the travel path of the vehicle 1.

For example, the memory 113 and the storage 115 may be implemented in one of storage mediums (or recovering mediums), such as a flash memory, a hard disk, a secure digital (SD) card, a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, a web storage, and the like.

According to the exemplary embodiment of the present disclosure, the user interface 117 may be implemented to receive a user's instruction. For example, the user interface 117 may output a graphic user interface (GUI). For example, the user interface 117 may output a user setting menu (USM).

The user interface 117 may transmit the input instruction to the processor 119. The user interface 117 may output different types of information or warnings according to the instruction transmitted from the processor 119. For example, the user interface 117 may include a speaker, a display device, and the like.

For example, the display device may include at least one of a liquid crystal display (LCD), a thin film transistor-liquid crystal display (TFT LCD), an organic light-emitting diode (OLED), a flexible display, and a 3D display, and a type of display realizing the display device is not limited thereto.

According to the exemplary embodiment of the present disclosure, the user interface 117 may display the travel path to provide the navigation service of the vehicle 1. For example, the user interface 117 may display various pop-up windows.

The processor 119 may perform the overall operation of the vehicle terminal 110. The processor 119 may perform the safe boarding and alighting assistance mode with respect to the vehicle 1 based on information or signals received through the communication module 111, algorithms/data stored in the memory 113, information stored in the storage 115, instructions or information input through the user interface 117, and the like.

To the present end, the processor 119 may be a data processing apparatus implemented in hardware having a circuit having a physical structure for activating desired operations. For example, the desired operations may include codes or instructions included in a program. For example, the data processing apparatus implemented in hardware may include a microprocessor, a central processing unit, a processor core, a multi-core processor, a multiprocessor, an application-specific integrated circuit (ASIC), and a field programmable gate array (FPGA).

### The controller 130

According to the exemplary embodiment of the present disclosure, the controller 130 may be configured for controlling the vehicle 1 based on the user's instruction or input. For example, the controller 130 may receive the instruction to enter the safe boarding and alighting assistance mode transmitted from the vehicle terminal 110 based on the user's instruction.

When the instruction to enter the safe boarding and alighting assistance mode is received, the controller 130 may enter the safe boarding and alighting assistance mode.

When entering the safe boarding and alighting assistance mode, the controller 130 may be operated based on the algorithm (safe boarding and alighting assistance algorithm) preset with respect to the safe boarding and alighting assistance mode.

According to the exemplary embodiment of the present disclosure, when entering the safe boarding and alighting assistance mode, the controller 130 may be configured to determine the operation state of the vehicle 1 based on the vehicle state information. When the vehicle 1 is in the travel state, the controller 130 may be configured for controlling the battery of the vehicle 1 based on the preset safe boarding and alighting charging algorithm. At the present point, the safe boarding and alighting charging algorithm may be an algorithm which is set about charging the battery of the vehicle 1 when the vehicle 1 is operated in the safe boarding and alighting assistance mode.

According to the exemplary embodiment of the present disclosure, the controller 130 may be configured to determine the operation state of the vehicle 1 based on the vehicle state information, such as vehicle speed information, transmission gear position information, emergency light state information, and the like.

For example, when the vehicle speed is less than or equal to a preset threshold speed, and a transmission gear is in the P position, the controller 130 may be configured to determine that the vehicle 1 is in a stop state. For example, when the vehicle speed is less than or equal to the preset threshold speed, the transmission gear is in the P position, and the emergency lights are on, the controller 130 may be configured to determine that the vehicle 1 is in the stop state.

According to the exemplary embodiment of the present disclosure, based on the preset safe boarding and alighting charging algorithm, the controller 130 may be configured for controlling the state of charge (SOC) value of the battery while considering the amount of the battery required by an electric field load in the stop state of the vehicle 1. For example, the electric field load includes air conditioning system, lighting system, infotainment system, etc.

To the present end, the controller 130 may store the information related to a preset safe boarding and alighting charging target SOC value. For example, when the vehicle control apparatus enters the safe boarding and alighting mode, the controller 130 may be configured for controlling charging of the battery so that the battery SOC reaches the safe boarding and alighting charging target SOC value.

At the present point, the safe boarding and alighting charging target SOC may be preset based on the electric power consumed by the electric field load of the vehicle 1 in the stop state of the vehicle 1, and may be preset by repeated tests.

When the battery of the vehicle 1 is greater than or equal to the safe boarding and alighting charging target SOC value, the battery charging based on engine starting in the stop state of the vehicle 1 is not performed. In other words, the safe boarding and alighting charging target SOC may be an SOC preset to limit the battery charging based on engine starting in the stop state of the vehicle 1.

For example, when the drive force is high, the controller 130 may actively use an engine free drive force to charge of the battery based on the travel path information (e.g., type of roads, traffic condition, station position information, etc.), so that the battery may obtain the safe boarding and alighting charging target SOC in advance.

According to the exemplary embodiment of the present disclosure, when the operation state of the vehicle 1 is in the stop state, the controller 130 may perform the preset engine starting limitation. For example, when the controller 130 performs the engine starting limitation, the controller 130 may output the engine starting limitation event signal to the vehicle terminal 110 so that the vehicle terminal 110 displays a message (engine starting limitation status message) that informs the vehicle user that engine starting is limited.

Accordingly, when the operation state of the vehicle 1 is in the stop state, the controller 130 may perform the engine start limitation and block the engine-based charging of the battery of the vehicle 1.

According to the exemplary embodiment of the present disclosure, when the operation state of the vehicle 1 is in the stop state, the vehicle 1 is located at a station and it is determined that another vehicle is within a preset radius (e.g., 5m, 10m, etc.) from the station, then the controller 130 performs the engine starting limitation.

For example, when the controller 130 receives the station arrival signal and the vehicle presence warning signal from the vehicle terminal 110, the controller 130 may perform the engine start limitation.

After entering the safe boarding and alighting assistance mode, when the door of the vehicle 1 is opened in the stop state of the vehicle 1, the controller 130 may limit the drive force of the vehicle 1. At the present point, the drive force limitation may include the limitation of drive force output.

For example, when the controller 130 performs the drive force limitation, the controller 130 may output the drive force limitation event signal to the vehicle terminal 110 and allow the vehicle terminal 110 to display a message (drive force limitation state message) that informs the vehicle user that the vehicle drive force is limited.

At the present point, the limiting the drive force of the vehicle 1 may be performed by limiting a powertrain output of the vehicle 1.

According to the exemplary embodiment of the present disclosure, the controller 130 may be configured for controlling the drive force of the vehicle 1 by maintaining the transmission gear in the N position, and fastening an electronic parking brake (EPB).

Likewise, when the controller 130 performs the drive force limitation with respect to the vehicle 1, even when the driver accidentally shifts the transmission gear and manipulates an accelerator pedal, it is possible to prevent the drive force of the vehicle 1 from being generated and to ensure the safety of the vehicle user boarding and alighting the vehicle, and to prevent vehicle slipping from occurring on a slope, and the like.

For example, the controller 130 may be implemented in a single controller or a plurality of controllers in a form with distributed functions.

For example, the controller 130 may be implemented in combination of a battery management system (BMS) managing (or controlling) the battery 120 and a higher controller (e.g., vehicle control unit (VCU), a hybrid control unit (HCU), and an integrated central control unit (ICU), and the like).

FIG. 3 is a view showing an example of a configuration of a controller according to the exemplary embodiment of the present disclosure.

Referring to FIG. 3, the controller 130 may include a communication module 131, a memory 133, a storage 135, and a processor 137, and the configuration of the controller 130 is not limited thereto.

The communication module 131 may receive different types of external information. The information received by the communication module 131 may be transmitted to the processor 137, stored in the memory 133, and stored in the storage 135.

For example, the communication module 131 may include communication circuits implemented to communicate with in-vehicle sensors. For example, the communication module 131 may include a communication circuit implemented to communicate the vehicle terminal 110, the distance measurement sensor group 200, and the image sensor group 300. For example, the communication module 131 may be implemented to perform communication based on the communication protocol, such as Local Interconnect Network (LIN), Controller Area Network (CAN), FlexRay, Ethernet, and the like.

For example, the communication module 131 may receive speed information from a speed sensor, transmission gear position information from a transmission gear position sensor, emergency light state information from an emergency light controller, and door opening and closing information from a door sensor, but the types of information are not limited thereto.

The memory 133 may store algorithms (or software or program), data, etc. required to perform the functions of the controller 130. For example, the memory 133 may store algorithms, data, etc., required to perform the safe boarding and alighting assistance mode according to the exemplary embodiment of the present disclosure by the controller 130.

The storage 135 may store data or/and information generated or obtained according to the operation of the controller 130. For example, the storage 135 may store data and/or information received by the controller 130 from an external device.

For example, the memory 133 and the storage 135 may be implemented in one of storage mediums (or recovering mediums), such as a flash memory, a hard disk, a secure digital (SD) card, a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, a web storage, and the like.

The processor 137 may perform the overall operation of the controller 130. The processor 137 may perform the safe boarding and alighting assistance mode for the vehicle, based on the information received through the communication module 131, the algorithms/data stored in the memory 133, the information stored in the storage 135, and the like.

To the present end, the processor 137 may be a data processing apparatus implemented in hardware including a circuit with a physical structure for activating desired operations. For example, the desired operations may include codes or instructions included in a program. For example, the data processing apparatus implemented in hardware may include a microprocessor, a central processing unit, a processor core, a multi-core processor, a multiprocessor, an application-specific integrated circuit (ASIC), and a field programmable gate array (FPGA).

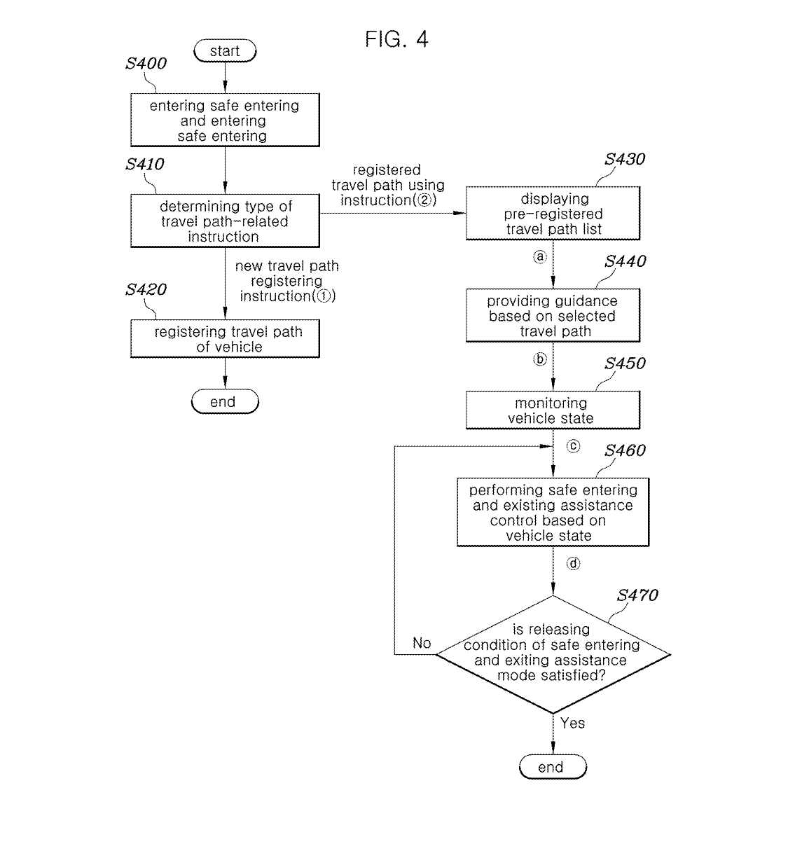

FIG. 4 is a view exemplarily illustrating a method for controlling the vehicle control apparatus according to the exemplary embodiment of the present disclosure.

Referring to FIG. 4, the vehicle control apparatus 100 may enter the safe boarding and alighting assistance mode, at S400.

For example, the vehicle terminal 110 may enter the safe boarding and alighting assistance mode, based on the instruction to enter the safe boarding and alighting assistance mode input through the USM displayed in the user interface 117. When the vehicle terminal 110 enters the safe boarding and alighting assistance mode, the instruction to enter the safe boarding and alighting assistance mode is output to the controller 130. Accordingly, the controller 130 may enter the safe boarding and alighting assistance mode.

Thereafter, the vehicle control apparatus 100 may be configured to determine a type of user's instruction related to the travel path, at S410.

According to the exemplary embodiment of the present disclosure, the vehicle control apparatus 100 may be configured to determine whether the user's instruction related to the travel path is an instruction to register a new travel path (hereinbelow, new travel path registering instruction) or an instruction to use a registered travel path (hereinbelow, registered travel path using instruction).

For example, the vehicle terminal 110 may receive the new travel path registering instruction or the registered travel path using instruction through the USM displayed in the user interface 117.

When the new travel path registering instruction is input ①, the vehicle control apparatus 100 may perform an operation of registering a new travel path based on the moving path of the vehicle 1, at S420.

When the new travel path registering instruction is input, the vehicle terminal 110 of the vehicle control apparatus 100 may enter a new travel path registration mode.

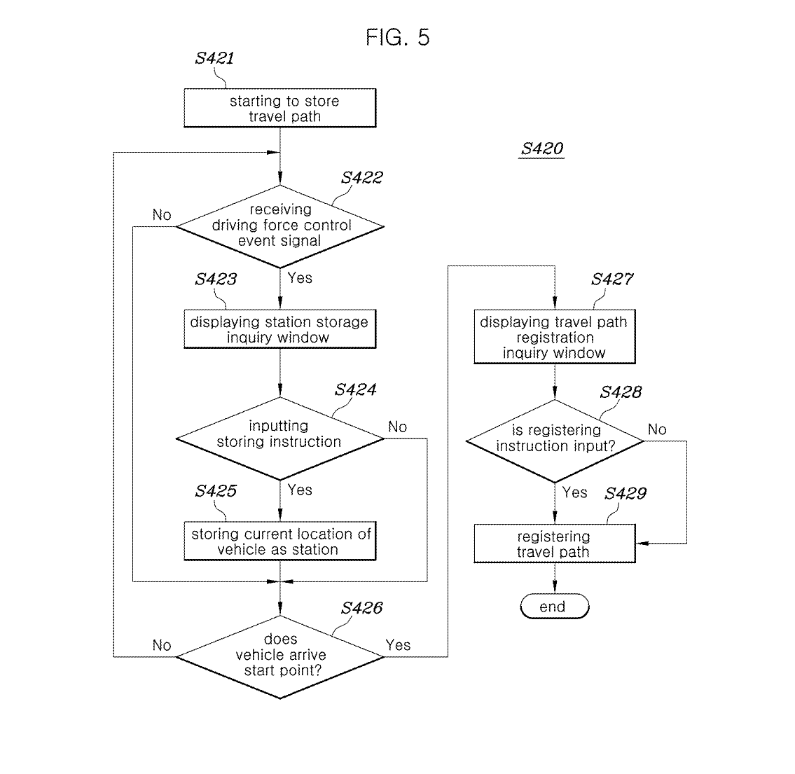

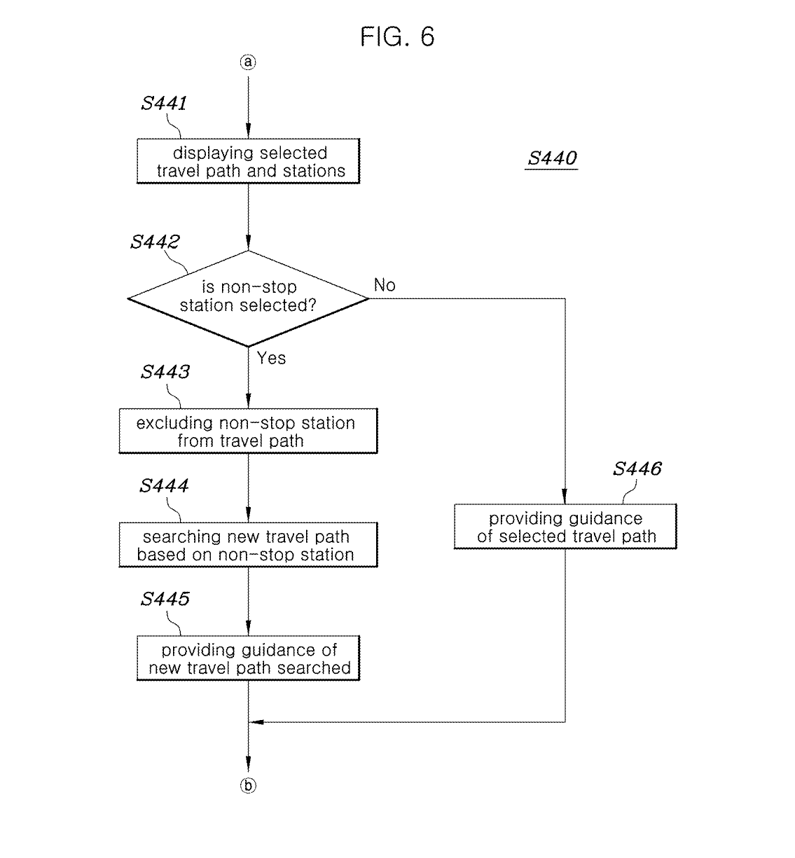

The operation of registering a new travel path S420 will be described below with reference to FIG. 5.

When the registered travel path using instruction is input ②, the vehicle terminal 110 may display a pre-registered travel path list on the user interface 117, at S430.

When the registered travel path using instruction is input, the vehicle terminal 110 of the vehicle control apparatus 100 may enter a registered travel path use mode.

Thereafter, the vehicle terminal 110 may provide guidance of a travel path of the vehicle 1 based on the travel path selected from the travel path list, at S440.

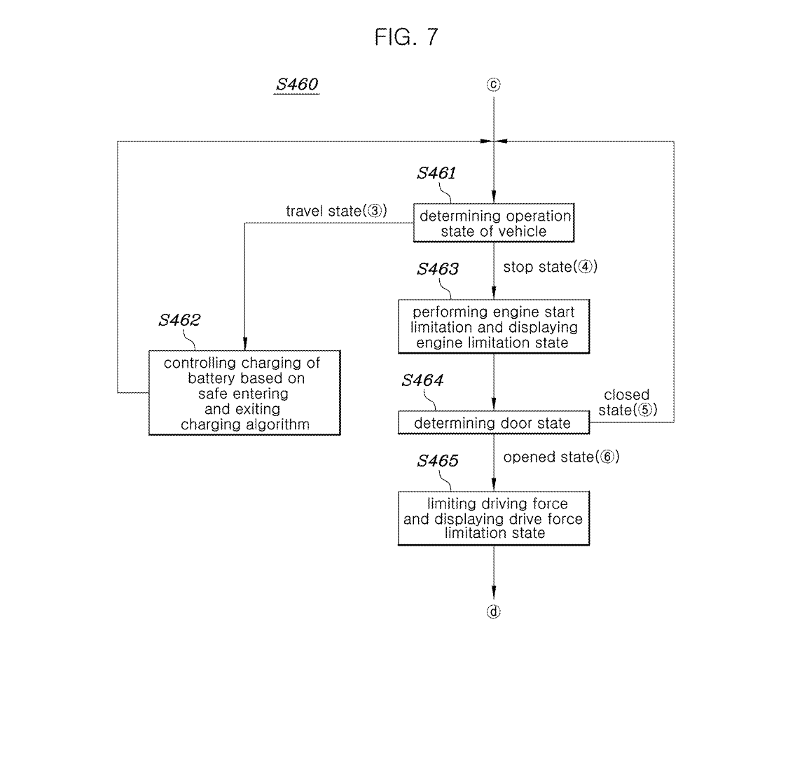

The operation of providing the guidance of the travel path S440 will be described below with reference to FIG. 6.

Thereafter, the controller 130 of the vehicle control apparatus 100, which enters the safe boarding and alighting assistance mode, may monitor a vehicle state at S450, and perform the safe entering and existing assistance control based on the monitored vehicle state, at S460.

The operation of performing the safe boarding and alighting assistance control at S460 will be described with reference to FIG. 7.

Thereafter, the controller 130 may be configured to determine whether a releasing condition of the safe boarding and alighting assistance mode is satisfied, at S470.

When the releasing condition of the safe boarding and alighting assistance mode is satisfied at S470-Yes, the controller 130 may terminate the operation of the safe boarding and alighting assistance mode.

When the releasing condition of the safe boarding and alighting assistance mode is not satisfied at S470-No, the controller 130 may perform the safe boarding and alighting assistance control based on the stage at S460.

FIG. 5 is a view exemplarily illustrating a new travel path registration operation in FIG. 4 in detail.

Referring to FIG. 5, when the vehicle terminal 110 receives the new travel path registering instruction ①, the vehicle terminal 110 may start storage of the travel path of the vehicle 1, at S421.

During the storage of the travel path, the vehicle terminal 110 may be configured to determine whether the driving force control event signal output from the controller 130 is received, at S422.

When the driving force control event signal is received at S422-Yes, the vehicle terminal 110 may display a pop-up window (station storage inquiry pop-up window) to inquire whether a current location of the vehicle 1 is stored as a station, on the user interface 117, at S423.

For example, the station storage inquiry pop-up window may include a storage button and a non-storage button.

Thereafter, the vehicle terminal 110 may be configured to determine whether a storing instruction is input, at S424.

When the storing instruction is input at S424-Yes, the vehicle terminal 110 may store the current location of the vehicle 1 as a station, at S425. At the present point, the inputting of the storing instruction may be performed when the user selects the storage button.

When the storing instruction is not input at S424-No, that is, a non-storing instruction is input, the vehicle terminal 110 may perform a next operation, at S426. At the present point, the inputting of the non-storing instruction may be performed when the user selects the non-storage button.

Thereafter, the vehicle terminal 110 may be configured to determine whether the vehicle 1 arrives at a start point, at S426.

When the vehicle 1 does not arrives at the start point at S426-No, the vehicle terminal 110 may store the travel path and perform the stages at S422 to 426.

Meanwhile, when the vehicle terminal 110 does not receive the driving force control event signal at S422-No, the vehicle terminal 110 may perform the stage, at S426.

When the vehicle 1 arrives at the start point at S426-Yes, the vehicle terminal 110 may display a pop-up window that inquires whether the currently stored travel path (travel path registration inquiry window) on the user interface 117 at S427.

For example, the travel path registration inquiry window may include a registration button and a non-registration button.

Thereafter, the vehicle terminal 110 may be configured to determine whether a registering instruction is input, at S428.

When the registering instruction is input at S428-Yes, the vehicle terminal 110 may register the currently registered travel path in the travel path list at S429. At the present point, the inputting of the registering instruction may be performed when the user selects the registration button.

When the registering instruction is not input at S428-No, that is, a non-registering instruction is input, the vehicle terminal 110 may terminate the travel path storage operation. At the present point, the inputting of the non-registering instruction may be performed when the user selects the non-registration button.

For example, the vehicle terminal 110 may remove the corresponding travel path before terminating the operation. For example, before removing the corresponding travel path, the vehicle terminal 110 may inquire whether the travel path is removed.

FIG. 6 is a view exemplarily illustrating a travel path guidance operation in FIG. 4 in detail.

Referring to FIG. 6, the vehicle terminal 110 may display a travel path selected from the travel path list and stations located in the travel path on the user interface 117, at S441.

The user can select a non-stop station among the stations located in the selected travel path. At the present point, the non-stop station may correspond to a station where the vehicle is not stopped at the current travel of the vehicle.

Thereafter, the vehicle terminal 110 may be configured to determine whether the station selected as a non-stop station exists among stations located in the displayed travel path, at S442.

When the station selected as a non-stop station is in the travel path at S442-Yes, the vehicle terminal 110 may exclude the station selected as a non-stop station from the travel path, at S443.

Thereafter, the vehicle terminal 110 may search a new travel path with respect to the travel path based on the non-stop station, at S444, and provide guidance of the newly searched travel path, at S445.

When the station selected as a non-stop station does not exist at S442-No, the vehicle terminal 110 may provide guidance of the selected travel path, at S446.

FIG. 7 is a view exemplarily illustrating a safe boarding and alighting assistance control operation at S460 in FIG. 4.

Referring to FIG. 7, the controller 130 of the vehicle control apparatus 100 may be configured to determine an operation state of the vehicle 1 based on the vehicle state information, at S461.

At S461, the controller 130 may be configured to determine whether the vehicle 1 is in the travel state or the stop state.

For example, the controller 130 may be configured to determine the operation state of the vehicle 1 based on the vehicle speed information, the transmission gear position information, the emergency light state information, and the like.

When the vehicle 1 is in the travel state at S461-③, the controller 130 may be configured for controlling battery charging of the vehicle 1 based on the preset safe boarding and alighting charging algorithm, at S462.

According to the exemplary embodiment of the present disclosure, the controller 130 may be configured for controlling charging of the battery so that the battery SOC reaches the preset safe boarding and alighting charging target SOC value.

When the vehicle 1 is in the stop state at S461-④, the controller 130 may perform the engine start limitation, at S463.

According to the exemplary embodiment of the present disclosure, the controller 130 may stop operation of the engine, and indicate the engine limitation state (or engine stop state) through the vehicle terminal 110.

According to the exemplary embodiment of the present disclosure, the controller 130 is configured to determine that the vehicle 1 is located at a station and another vehicle is within a preset radius (e.g., 5m, 10m, etc.) from the station, then performs the engine starting limitation.

For example, when the controller 130 receives the station arrival signal and the vehicle presence warning signal from the vehicle terminal 110, the controller 130 may perform the engine start limitation.

Thereafter, the controller 130 may be configured to determine the door state based on the door state information at S464. At S464, the controller 130 may be configured to determine whether the door of the vehicle 1 is in an opened or closed state.

When the door of the vehicle 1 is in the closed state at S464-⑤), the controller 130 may perform the determination of the operation state, at S461.

When the door of the vehicle 1 is in the open state at S464-⑥, the controller 130 may limit the drive force of the vehicle 1 at S465. According to the exemplary embodiment of the present disclosure, the controller 130 may display the drive force limitation state on the vehicle terminal 110.

At 465, the controller 130 may maintain the transmission gear in the N position. Furthermore, the controller 130 may allow the electronic parking brake (EPB) to be engaged.

According to the exemplary embodiment of the present disclosure, when the controller 130 receives the station arrival signal and the vehicle presence warning signal from the vehicle terminal 110, the controller 130 may perform the drive force limitation.

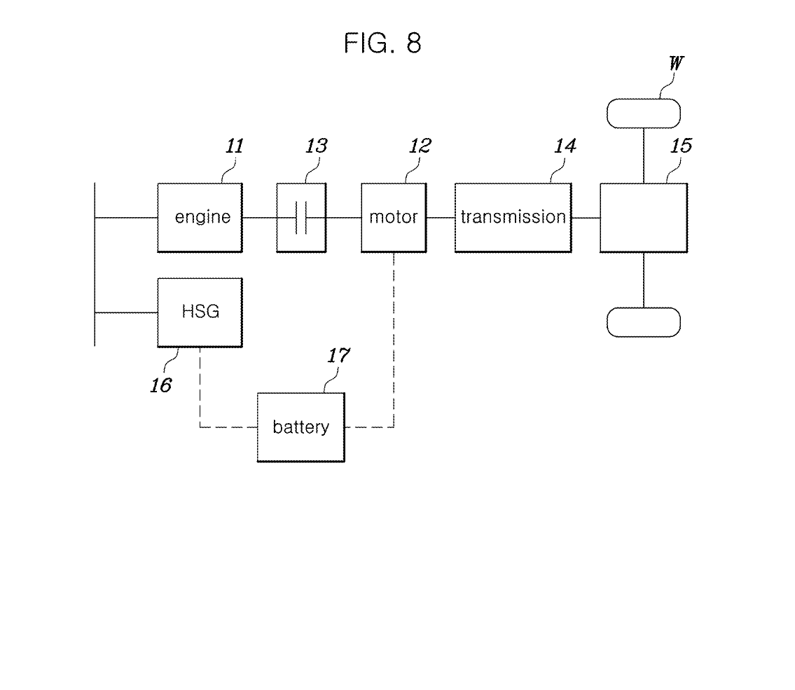

FIG. 8 is a view showing a power system of the vehicle 1 to which the vehicle control apparatus 100 according to the exemplary embodiment of the present disclosure is applied, and the view illustrates a transmission disposed electric drive (TMED) system.

Referring to FIG. 8, the vehicle power system may include an engine 11, a motor 12, an engine clutch 13 disposed between the engine 11 and the motor 12 and transmitting or cutting off engine power, a transmission 14 transmitting or outputting power of the motor 12, a final reduction gear 15 coupled to the transmission 14 and transmitting power of the transmission 14 to the driving wheel W, a hybrid starter generator (HSG) 16 connected to the engine 11 to start the engine and generate power, a battery 17 connected to the motor 12 and the hybrid starter generator 16 to be chargeable or dischargeable, and the like.

According to the exemplary embodiment of the present disclosure, the transmission 14 may be implemented in an auto transmission (AT), a dual clutch transmission (DCT), and the like.

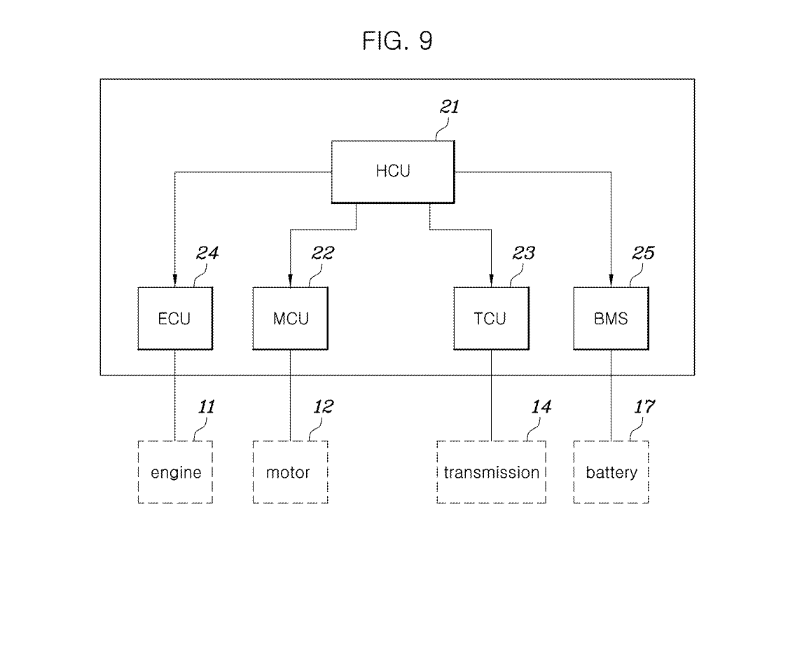

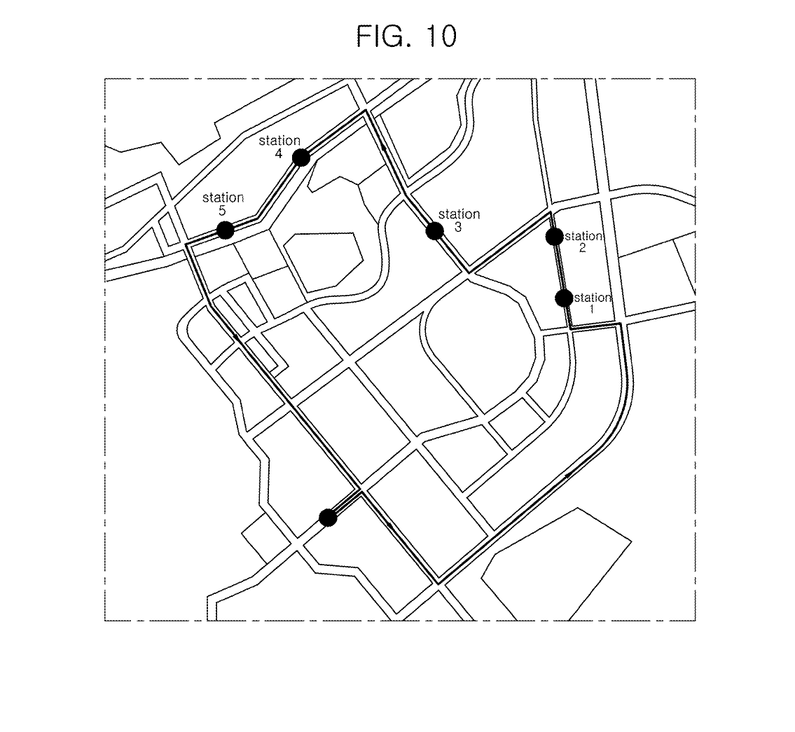

FIG. 9 is an example of a control block diagram for controlling the vehicle according to the exemplary embodiment of the present disclosure.

Referring to FIG. 9, the vehicle control apparatus may include a hybrid control unit (HCU) 21, a motor control unit (MCU) 22, a transmission control unit (TCU) 23, an engine control unit (ECU) 24, a battery management unit (BMS) 25, and the like.

The hybrid control unit 21 is a higher controller that outputs a torque command according to a travelling condition, and may be configured for controlling a motor control unit 22, a transmission control unit 23, an engine control unit 24, and a battery management unit 25, which are lower controllers.

For example, the hybrid control unit 21 may communicate with a vehicle network, for example, communicate with the lower control unit 22, 23, 24, 25 based on a Controller Area Network (CAN).

The hybrid control unit 21 may perform control with respect to the lower control units 22, 23, 24, and 25, and receive information related to the devices 11, 12, 14, and 17, which are managed and controlled by the lower control unit 22, 23, 24, 25, from the lower control unit 22, 23, 24, 25.

According to the exemplary embodiment of the present disclosure, when the vehicle enters the safe boarding and alighting mode, the hybrid control unit 21 may be configured to determine the operation state of the vehicle 1.

When the vehicle is in the travel state, the hybrid control unit 21 may output the instruction to enter the safe boarding and alighting mode to the battery management unit 25. Accordingly, the battery management unit 25 may enter the safe boarding and alighting mode, and control charging of the battery 17 based on the preset safe boarding and alighting charging algorithm.

Accordingly, the hybrid control unit 21 may perform the engine starting limitation when the vehicle 1 is in the stop state. The hybrid control unit 21 may transmit an instruction to enter the safe boarding and alighting mode to the engine control unit 24, and the engine control unit 24 may enter the safe boarding and alighting mode and stop operation of the engine 11.

According to the exemplary embodiment of the present disclosure, when the door of the vehicle 1 is opened in the safe boarding and alighting mode, the hybrid control unit 21 may limit the drive force of the vehicle 1. The hybrid control unit 21 may output an N-position maintaining order to the transmission control unit 23.

The motor control unit 22 may receive a torque order of the hybrid control unit 21, and control overall operation with respect to the motor 12.

The transmission control unit 23 may be configured for controlling a shift position of the transmission 14 according to a travelling situation, and the engine control unit 24 may be configured for controlling an overall operation and an operating point of the engine 11 according to the order of the hybrid control unit 21, and the battery management unit 117 may collect battery state information and use the information to control charging and discharging of the battery 17 or provide the information to the hybrid control unit 21.

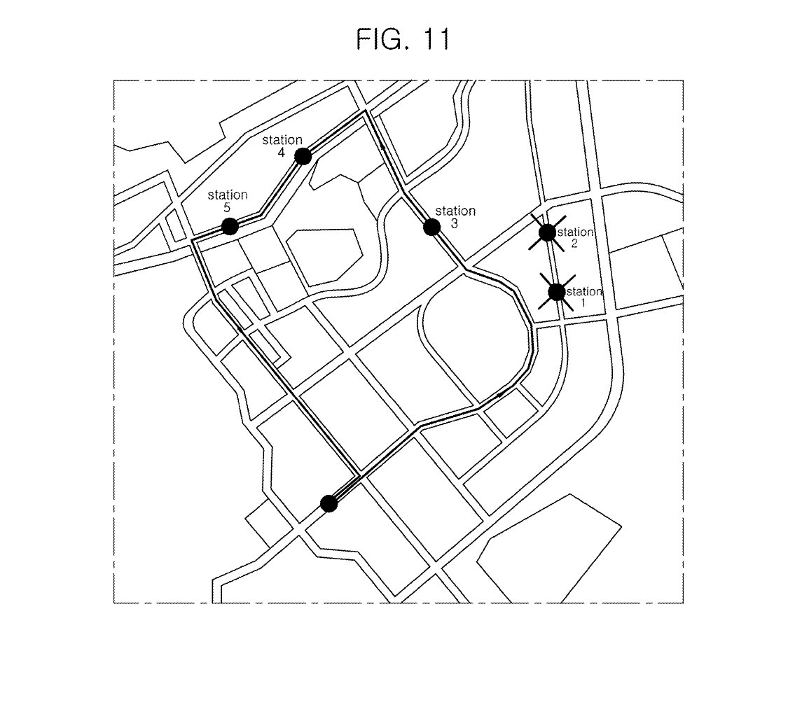

FIG. 10 is a view showing an example of a travel path registered by a new travel path registration operation of the vehicle terminal according to an exemplary embodiment of the present disclosure. FIG. 11 is a view showing an example of a new travel path which is searched in a situation without stations 1 and 2 from FIG. 10.

As described above, according to the exemplary embodiment of the present disclosure, the vehicle terminal 110 may provide the registered travel path, and also search and provide a new travel path when a station is excluded from the registered travel path.

Although the specific embodiments of the present disclosure have been provided, it is apparent to one of ordinary skill in the art that the present disclosure may be changed and modified in various ways without departing from the scope of the present disclosure, which is provided in the following claims.

What is claimed is:

1. An apparatus for controlling a hybrid vehicle including a hybrid powertrain of an engine and a drive motor, the apparatus comprising:
a vehicle terminal, based on entering a safe boarding and alighting assistance mode and receiving an instruction to use a registered travel path, configured to display path guidance information based on a pre-registered travel path; and
a controller configured to determine a state of the vehicle based on a location of the vehicle and vehicle state information based on entering the safe boarding and alighting assistance mode, and perform limit control of the hybrid powertrain based on that the vehicle is in a state of being able to board and alight.

2. The apparatus of claim 1, wherein, based on that the instruction to use the registered travel path is input, the vehicle terminal is further configured to display a registered travel path list, determine whether a non-stop station is selected from a travel path selected from the travel path list, and provide guidance of a travel path based on whether the non-stop station is selected.

3. The apparatus of claim 2, wherein, based on that the non-stop station is selected, the vehicle terminal is further configured to exclude the selected non-stop station from the travel path and search a new travel path, and provide guidance of the new travel path searched.

4. The apparatus of claim 2, wherein, based on that the non-stop station is not selected, the vehicle terminal is further configured to provide guidance of the selected travel path.

5. The apparatus of claim 1, wherein, based on that an instruction to register a new travel path is input after entering the safe boarding and alighting assistance mode, the vehicle terminal is further configured to store a travel path corresponding to a travel of the vehicle and a station on the travel path.

6. The apparatus of claim 5, wherein, based on that the vehicle terminal receives a driving force control event signal from the controller during the travel of the vehicle, the vehicle terminal is further configured to display a pop-up window that inquires whether a current location of the vehicle is stored as a station, and store the current location of the vehicle as the station based on that a storing instruction is input through the pop-up window.

7. The apparatus of claim 1, wherein, based on entering the safe boarding and alighting assistance mode, the vehicle terminal is further configured to output an instruction to enter the safe boarding and alighting assistance mode to the controller.

8. The apparatus of claim 1, wherein based on that the vehicle is in a travel state, the controller is further configured to control a battery of the vehicle so that a state of charge (SOC) value of the battery of the vehicle reaches a preset safe boarding and alighting charging target SOC value.

9. The apparatus of claim 8, wherein the preset safe boarding and alighting charging target SOC is preset greater than or equal to electric power consumed by an electric field load of the vehicle based on that the vehicle is stopped.

10. The apparatus of claim 1, wherein the state of being able to board and alight is a state in which the vehicle is stopped and located at a station on the travel path with a door of the vehicle opened.

11. The apparatus of claim 10, wherein, based on receiving a station arrival signal from the vehicle terminal, the controller is further configured to determine that the vehicle is located at the station on the travel path.

12. The apparatus of claim 1, wherein, based on that the vehicle is in the state of being able to board and alight, the controller is further configured to maintain the engine in an OFF state.

13. The apparatus of claim 1, wherein, based on that the vehicle is in the state of being able to board and alight, the controller is further configured to limit a driving force output of the hybrid powertrain.

14. The apparatus of claim 13, wherein, based on limiting the driving force output of the hybrid powertrain, the controller is further configured to control a gear of the vehicle so that the gear is maintained in an N position.

15. The apparatus of claim 13, wherein based on limiting the driving force output of the hybrid powertrain, the controller is further configured to control an electronic parking brake of the vehicle so that the electronic parking brake is maintained in an engaged state.

16. The apparatus of claim 1, wherein the vehicle terminal comprises:
a communication module implemented to communicate with electronic devices in the vehicle;
a memory implemented to store a safe boarding and alighting assistance algorithm;
a user interface implemented to receive the instruction from a user and display information; and
a processor configured to perform the safe boarding and alighting assistance algorithm based on entering a safe boarding and alighting mode.

17. The apparatus of claim 1, wherein the controller comprises:
a communication module implemented to communicate with electronic devices in the vehicle;
a memory implemented to store a safe boarding and alighting assistance algorithm; and
a processor configured to perform the safe boarding and alighting assistance algorithm based on entering a safe boarding and alighting mode.

18. A method for controlling a hybrid vehicle including a hybrid powertrain of an engine and a drive motor, the method comprising:
entering a vehicle terminal and a controller into a safe boarding and alighting assistance mode;
displaying, by the vehicle terminal, path guidance information based on a pre-registered travel path; and
determining, by the controller, a state of the vehicle based on a location of the vehicle and vehicle state information; and
performing, by the controller, limit control with respect to the hybrid powertrain based on that the vehicle is in a state of being able to board and alight.

19. A hybrid vehicle including a hybrid powertrain of an engine and a drive motor, the hybrid vehicle comprising:
a vehicle control apparatus configured to display path guidance information based on a pre-registered travel path based on entering a safe boarding and alighting assistance mode, and control the hybrid vehicle based on a preset safe boarding and alighting assistance algorithm,
wherein the vehicle control apparatus is further configured to determine a state of the vehicle based on the safe boarding and alighting assistance algorithm, location information, and state information of the vehicle, and to perform limit control with respect to the hybrid powertrain based on that the vehicle is in a state of being able to board and alight.

20. The hybrid vehicle of claim 19, wherein the vehicle control apparatus comprises:
a vehicle terminal configured to provide guidance of a travel path of the vehicle based on the registered travel path, based on entering the safe boarding and alighting assistance mode and receiving an instruction to use the registered travel path; and
a controller configured to perform the boarding and alighting assistance algorithm after entering the safe boarding and alighting assistance mode.
